(19) United States
(12) Patent Application Publication
(10) Pub. No.: US 2004/0223494 A1
(43) Pub. Date: Nov. 11, 2004

(54) Traffic forwarding method in ATM based MPLS system and apparatus thereof

(75) Inventor: Seob No Lee, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/828,339

(22) Filed: Apr. 21, 2004

(30) Foreign Application Priority Data
May 6, 2003 (KR) P2003-0028622
Jan. 20, 2004 (KR) P2004-0004155

(51) Int. Cl. H04L 12/28

(52) U.S. Cl. 370/395.1; 370/352

(57) ABSTRACT

A traffic forwarding method in an ATM (asynchronous transfer mode) based MPLS (multi-protocol label switching) system and apparatus thereof is disclosed, by which the traffic flowing into an egress is effectively forwarded. The present invention includes classifying ATM traffic of traffic inputted to an egress through at least one channel, into non-UBR (unspecified bit rate) traffic and UBR traffic, finding a total of channel bandwidths assigned to the classified non-UBR traffic, and forwarding the classified non-UBR traffic through a single channel having a bandwidth amounting to the found total.

The present application claims priority from Korean Patent Application Nos. P2003-0028622 filed on May 6, 2003, and P2004-0004155 filed on Jan. 20, 2004, the subject matter of which are incorporated herein by reference.

### BACKGROUND OF THE INVENTION

1. Field of the Invention

The present invention generally relates to an ATM (asynchronous transfer mode) MPLS (multi-protocol label switching) system, and more particularly, to a traffic forwarding method in an ATM based MPLS system and apparatus thereof, by which the traffic flowing into an egress are effectively forwarded.

2. Background of the Related Art

The present invention generally relates to an ATM (asynchronous transfer mode) MPLS (multi-protocol label switching) system, and more particularly, to a traffic forwarding method in an ATM based MPLS system and apparatus thereof, by which the traffic flowing into an egress are effectively forwarded.

Generally, when an ATM based MPLS system lying on a boundary of a network is used as a label edge router (LER) performing a function of traffic transmission through interworking between packets of a conventional network layer (IP packet) and MPLS packets, a pure ATM traffic requiring a second layer (layer 2) processing and an MPLS traffic requiring a third layer (layer 3) are mixed to flow into a corresponding system.

In processing the ATM traffic flowing into the MPLS system together with the MPLS traffic, there is a method, as shown in FIG. 1, of processing the ATM traffic separated from the MPLS traffic. Another method is shown in FIG. 2, of processing the ATM traffic together with the MPLS traffic by performing a traffic control on all ATM traffic channels.

Referring to FIG. 1, a block diagram is shown of an MPLS system 10 according to a related art. ATM and MPLS traffic inputted via a traffic receiving unit 11 are separated from each other by a traffic demultiplexing unit 12. The separated MPLS traffic undergoes a third layer processing in a forwarding engine 13, and is then mixed with the separated ATM traffic by a traffic multiplexing unit 14 and outputted via a traffic transmitting unit 15.

Referring to FIG. 2, a block diagram is shown of another MPLS system 20 according to a related art. ATM and MPLS traffic inputted via a traffic receiving unit 21 are processed by a forwarding engine 22. The ATM traffic undergoes a traffic control performed on all ATM traffic channels, and is then outputted via a traffic transmitting unit 23.

As mentioned in the foregoing explanation, in the case that the ATM traffic is separated from the MPLS traffic to be processed, the traffic demultiplexing and multiplexing units are additionally needed to separate the traffic from each other. Yet, such features are technically difficult to implement, and construction of the system becomes complicated.

Moreover, in case that both the ATM and MPLS traffic are processed in the forwarding engine, the forwarding engine has to control the respective channels for the entire ATM traffic. Hence, the previous load according to MPLS traffic processing is weighed with the load according to ATM traffic processing, whereby system performance is degraded.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Accordingly, the present invention is directed to a traffic forwarding method in an ATM based MPLS system and apparatus thereof that substantially obviates one or more problems due to limitations and disadvantages of the related art.

Another object of the present invention is to provide a traffic forwarding method in an ATM based MPLS system and apparatus thereof, by which system performance is enhanced by processing ATM traffic together with MPLS traffic on the condition that a control of each channel for the ATM traffic is excluded.

To achieve these objects and other advantages in accordance with the purpose of the invention, as embodied and broadly described herein, a traffic forwarding method in an ATM based MPLS system according to the present invention includes the steps of classifying traffic inputted to an egress through at least one channel by rate, acquiring a total of channel bandwidths of ATM traffic of the inputted traffic corresponding to at least one setup rate, and forwarding the ATM traffic corresponding to the setup rate through a single channel having the acquired bandwidth. The traffic forwarding method further includes the steps of forwarding MPLS traffic of the inputted traffic by subscriber channel according to a priority of the classified rate, performing processing on a second layer of the forwarded traffic, and matching the processed traffic to a physical layer.

In the rate classifying step, the rate includes CBR (constant bit rate), RT-VBR (real-time variable bit rate), NRT-VBR (non-real-time variable bit rate), and UBR (unspecified bit rate), in hierarchical order. The setup rate includes the CBR, RT-VBR, and NRT-VBR rates, and, the ATM traffic corresponding to the setup rate is real-time traffic.

In another aspect of the present invention, a traffic forwarding apparatus in an ATM based MPLS system includes a traffic rate classifying unit classifying traffic inputted to an egress by rate, wherein ATM traffic of the inputted traffic is classified into a non-UBR traffic rate and a UBR traffic rate and wherein MPLS traffic of the inputted traffic is classified into CBR, RT-VBR, NRT-VBR, and UBR rates, in hierarchical order. The traffic formatting apparatus also includes a traffic storing unit including an ATM traffic storing unit having a first buffer buffering the ATM traffic corresponding to the non-UBR rate, a second buffer buffering the ATM traffic corresponding to the UBR rate, and an MPLS traffic storing unit having a plurality of buffers buffering the MPLS traffic by the classified rate and by channel, and a scheduler forwarding the traffic stored in the traffic storing unit according to a priority of each of the classified rates. The traffic forwarding apparatus further includes an ATM processing unit performing processing on a second layer of the forwarded traffic, and a physical layer matching unit matching the processed traffic to a physical layer.

The scheduler forwards the ATM traffic of non-UBR rate stored in the first buffer unit with the same priority of the MPLS traffic of the CBR rate, finds a total of channel bandwidths of the ATM traffic corresponding to the non-UBR rate, and forwards the ATM traffic stored in the first buffer unit through a single channel having a bandwidth amounting to the found total.

The foregoing general description and the following detailed description of the present invention are exemplary and explanatory and are intended to provide further explanation of the invention as claimed.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram of an MPLS system for processing ATM traffic separated from MPLS traffic according to a related art;

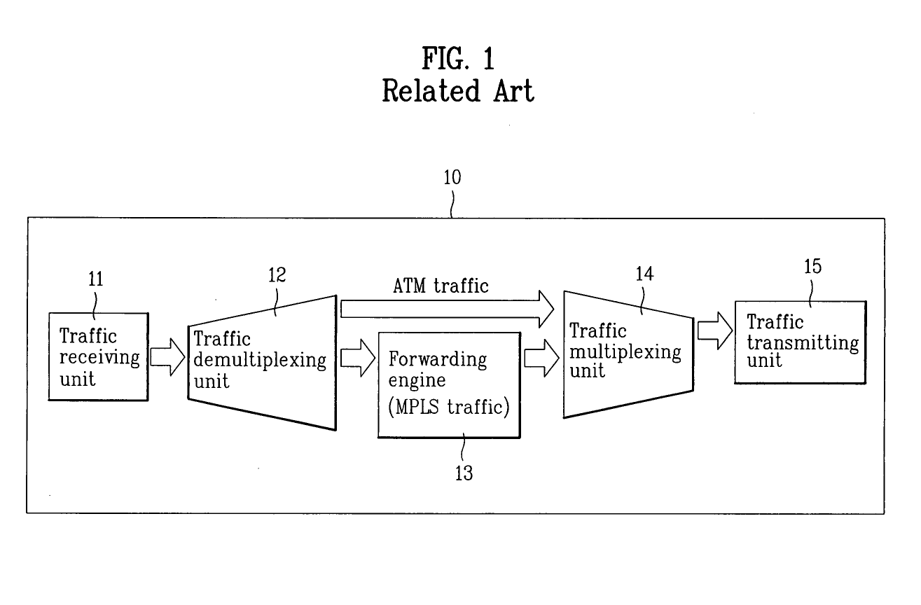

FIG. 2 is a block diagram of an MPLS system for processing ATM traffic together with MPLS traffic according to a related art;

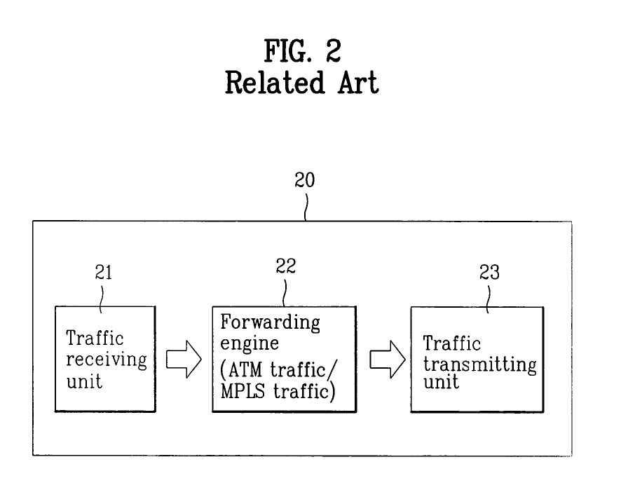

FIG. 3 is a block diagram of an ATM based MPLS system according to an embodiment of the present invention;

FIG. 4 is a block diagram of an egress of a forwarding engine in FIG. 3;

FIG. 5 is a flowchart of a traffic forwarding method in an ATM based MPLS system according to another embodiment of the present invention; and

FIG. 6 is a detailed flowchart of a traffic forwarding method in an ATM based MPLS system according to another embodiment of the present invention.

### DETAILED DESCRIPTION OF PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

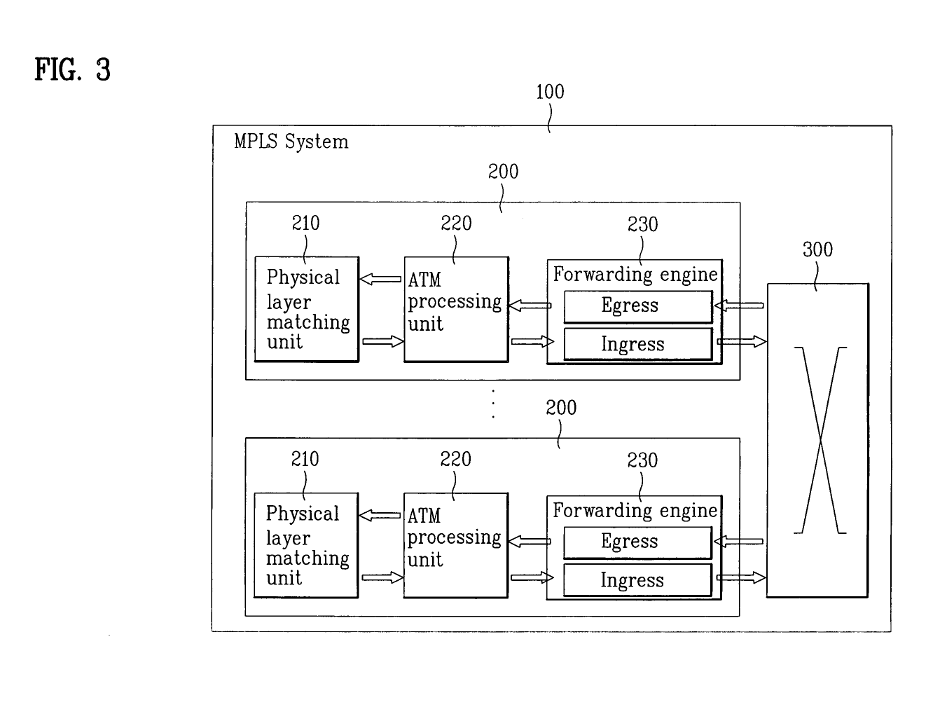

FIG. 3 is a block diagram of an ATM based MPLS system 100 according to one embodiment of the present invention.

Referring to FIG. 3, an ATM based MPLS system 100 according to an embodiment of the present invention includes a plurality of matching devices 200 and a switching unit 300 switching traffic packets to the corresponding matching device 200.

Each of the matching devices 200 includes a physical layer matching unit 210 matched to a physical layer (PHY) to transmit/receive ATM or MPLS traffic, an ATM processing unit 220 performing processing on a second layer (layer2) of the traffic transmitted/received through the physical layer matching unit 210, and a forwarding engine 230 having an ingress forwarding the traffic received through the ATM processing unit 220 to the switching unit 300 and an egress forwarding the traffic switched by the switching unit 300 to the ATM processing unit 220.

The egress of the forwarding engine 230 classifies the ATM traffic among the traffic flowing from the switching unit 300 via at least one channel into non-UBR traffic and UBR traffic, finds a total of bandwidths assigned to the classified non-UBR traffic per channel, forwards the classified non-UBR traffic to the ATM processing unit 220 via one channel having the found total, classifies the MPLS packets among the flowing-in traffic into rates, and forwards the classified MPLS traffic to the ATM processing unit 220 on a per channel basis according to priorities of the classified rates, respectively.

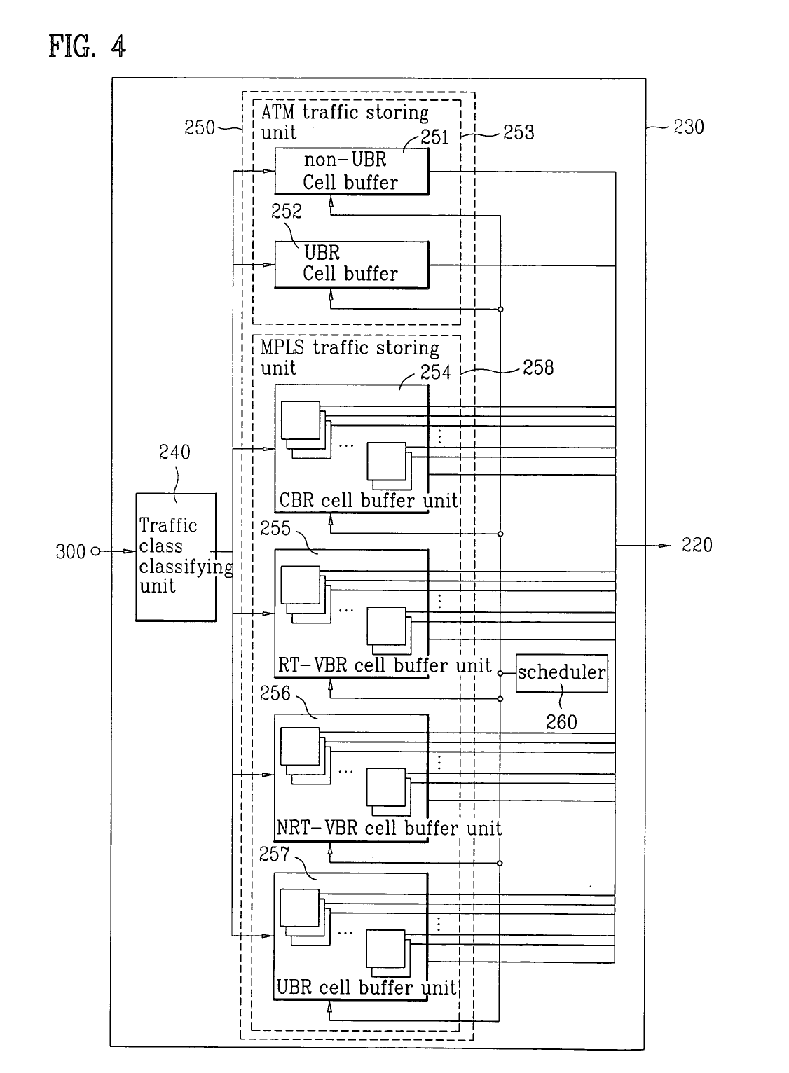

FIG. 4 is a block diagram of the egress of the forwarding engine 230 in FIG. 3.

Referring to FIG. 4, the egress of the forwarding engine 230 includes a traffic rate classifying unit 240 classifying the ATM and/or MPLS traffic flowing into the egress via at least one channel into rates, a storing unit 250 buffering the flowing-in ATM/MPLS traffic according to the rates classified by the traffic rate classifying unit 240, and a scheduler 260 forwarding the ATM/MPLS traffic stored in the storing unit 250 according to the priorities based on the classified rates.

The traffic rate classifying unit 240 classifies the ATM traffic among the flowing-in traffic into the non-UBR and UBR rates, classifies the MPLS traffic into CBR, RT-VBR, NRT-VBR, and UBR rates, in hierarchical order, and classifies each of the classified rates per channel. Such rates are determined by a contract of a user's subscription.

The UBR is a rate that does not assign a fixed bandwidth of channel for connection between users but assigns a maximum bandwidth within the available bandwidth in use to service. The UBR rate is not guaranteed against data discarded because of congestion occurring during servicing. The non-UBR indicates a rate that a fixed channel is assigned to a user. In the embodiment of the present invention, the non-traffic rate includes the CBR, RT-VBR, and NRT-VBR rates for example.

Traffic corresponding to the CBR and RT-VBR rates are real-time traffic enabling to be provided with real-time services such as voice data. The traffic of such rates are serviced in real time by always assigning a fixed bandwidth in an exchange. NRT-VBR, UBR, ABR (available bit rate), etc. are the rates that provide non-real-time services such as e-mail and facsimile data.

The storing unit 250 includes an ATM traffic storing unit 253 having a non-UBR cell buffer 251 buffering cells of the non-UBR rated ATM traffic and a UBR cell buffer 252 buffering cells of the UBR-rated ATM traffic and an MPLS traffic storing unit 258 having a plurality of buffers buffering the flowing-in MPLS traffic by the classified rates and the channels.

The MPLS traffic storing unit 258 includes a CBR cell buffer unit 254 having a plurality of buffers to buffer CBR cells by channels, an RT-VBR cell buffer unit 255 having a plurality of buffers to buffer RT-VBR cells by channels, an NRT-VBR cell buffer unit 256 having a plurality of buffers to buffer NRT-VBR cells by channels, and a UBR cell buffer unit 257 having a plurality of buffers to buffer UBR cells by channels.

Namely, in the storing unit 250, the non-UBR cell buffer 251 and the UBR cell buffer 252 of the ATM traffic storing unit 253 each includes one buffer, whereas each of the CBR, RT-VBR, NRT-VBR, and UBR cell buffer units 254, 255, 256, and 257 of the MPLS traffic storing unit 258 includes a plurality of buffers.

The scheduler 260 forwards the traffic of the flowing-in ATM traffic, which are classified into the non-UBR rate to be stored in the non-UBR cell buffer 251, by the same priority of the CBRrate traffic of the MPLS traffic stored in the CBR cell buffer 254.

The scheduler 260 also forwards the flowing-in ATM traffic stored in the non-UBR cell buffer 251 on one channel of which bandwidth is equal to the total bandwidths of the corresponding channels of the ATM traffic.

The ATM processing unit 220 performs processing on a second layer of the received traffic forwarded from the ATM and/or MPLS traffic storing unit 253 and/or 258 by the scheduler 260. The physical layer matching unit 210 matches the traffic received from the ATM processing unit 220 to the physical layer to output externally.

An operation of the egress of the forwarding engine in FIG. 4 and a traffic forwarding method in an ATM based MPLS system according to one embodiment of the present invention are explained as follows.

Referring to FIG. 4, the egress of the forwarding engine 230 concurrently carries out the existing MPLS traffic processing and ATM traffic processing. However, the egress of the forwarding engine 230 does not control the ATM traffic, which does not require a third layer processing, and is processed by one non-UBR channel having the same priority of a CBR channel.

In order to forward the ATM traffic, the traffic rate classifying unit 240 classifies the CBR, RT-VBR, and NRTVBRrate traffic of the ATM traffic inputted via at least one channel into the non-UBR traffic to store in the non-UBR cell buffer 251, and stores the rest of the UBR traffic in the UBR cell buffer 252.

Subsequently, based on the total bandwidths assigned to the channels of respective traffic classified as non-UBR traffic, the scheduler 260 assigns the bandwidth amounting to the total bandwidths to the single channel for the forwarding of the non-UBR traffic stored in the non-UBR buffer 251, and forwards them according to the priorities associated with traffic stored in other buffers.

The scheduler 260 is enabled to be provided with information of the total ATM traffic bands, which are assigned, by a higher system control unit 270 to respective channels connected to the matching device 200 to which the scheduler 260 itself belongs.

The traffic rate classifying unit 240 stores the inputted ATM traffic cells, which are the CBR, RT-VBR, and NRT-VBR cells having fixed bands assigned thereto, in the non-UBR cell buffer 251, whereby the scheduler 260 forwards them to the band (total ATM traffic band) assigned to the corresponding channel via the non-UBR traffic channel having the same priority of the CBR traffic channel. In case of the UBR traffic cells to which the band is not assigned, the traffic rate classifying unit 240 stores them in the UBR cell buffer 252 and then forwards them to the corresponding band via the UBR traffic channel if there exists an available band assigned to the non-UBR traffic channel.

Hence, the traffic of the ATM traffic with the exception of the UBR traffic avoid influence of the MPLS traffic to be processed, and the UBR traffic of the ATM traffic is processed with the same priority as the UBR traffic of the MPLS traffic, whereby quality of service (QoS) is guaranteed.

When the respective matching devices 200 are driven, an operator assigns the band to be used by the ATM traffic to the system control unit 270 per each channel. The higher system control unit 270 totals the ATM traffic bands to transfer to the forwarding engine 230 using IPC (inter process communication).

Table 1 illustrates an exemplary channel traffic band fixedly assigned to each user.

TABLE 1

Traffic band (Mbps)

| Physical layer | ATM | MPLS |
|---|---|---|
| Channel #0 | 5 | 85 |
| Channel #1 | 10 | 90 |
| Channel #2 | 15 | 75 |
| Channel #3 | 20 | 60 |

In reference to table 1, when the operator assigns the ATM traffic band to the system control unit 270 per channel assigned to each user in driving the corresponding matching device 200, the system control unit 270 totals the ATM traffic bands of the respective channels and transfers information of the total ATM traffic band (50 Mbps) to the forwarding engine 230 through IPC.

The forwarding engine 230 assigns the total ATM traffic band (50 Mbps) to one non-UBR traffic channel, and performs forwarding through the non-UBR channel at 50 Mbps when the CBR, RT-VBR, or NRT-VBR cells are inputted.

In the case of MPLS traffic, the forwarding engine 230 stores the traffic in the CBR, RT-VBR, NRT-VBR, and UBR cell buffer units 254, 255, 256, and 257 according to the grades of the traffic by channels, respectively, and then forwards the traffic to the assigned bands of the traffic by the corresponding channels according to the priorities set through the scheduler 260.

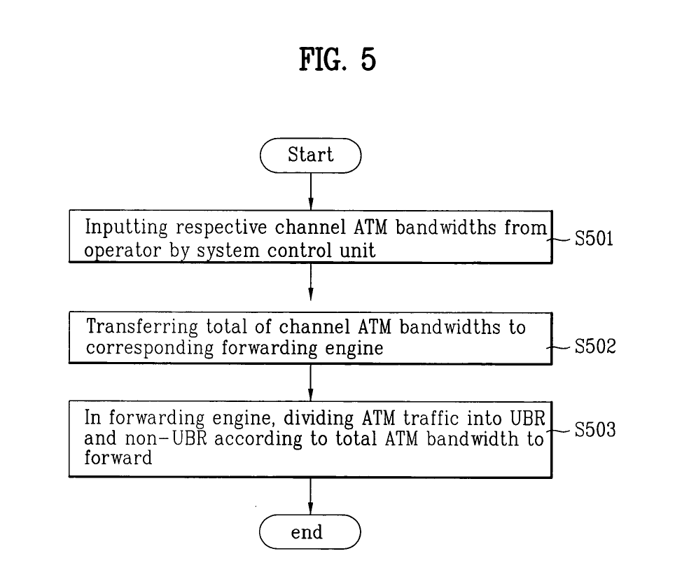

FIG. 5 is a flowchart of a traffic forwarding method in an ATM based MPLS system according to another embodiment of the present invention.

Referring to FIG. 5, in driving the matching devices 200, the system control unit 270 of the MPLS system receives information of an ATM band per channel assigned to a physical layer connected to each corresponding one of the matching devices 200 (S501).

The system control unit 270 totals the bands respectively assigned to the channels of the CBR, RT-VBR, and NRT VBR traffic of the non-UBR rated ATM traffic, and then transfers the total band to the corresponding forwarding engine 230 through IPC (S502).

The scheduler 260 of the corresponding forwarding engine 230 assigns the total ATM band to one non-UBR channel having the same priority as the CBR traffic channel of the MPLS traffic, and then divides the inputted ATM traffic into UBR traffic and non-UBR traffic for forwarding (S503).

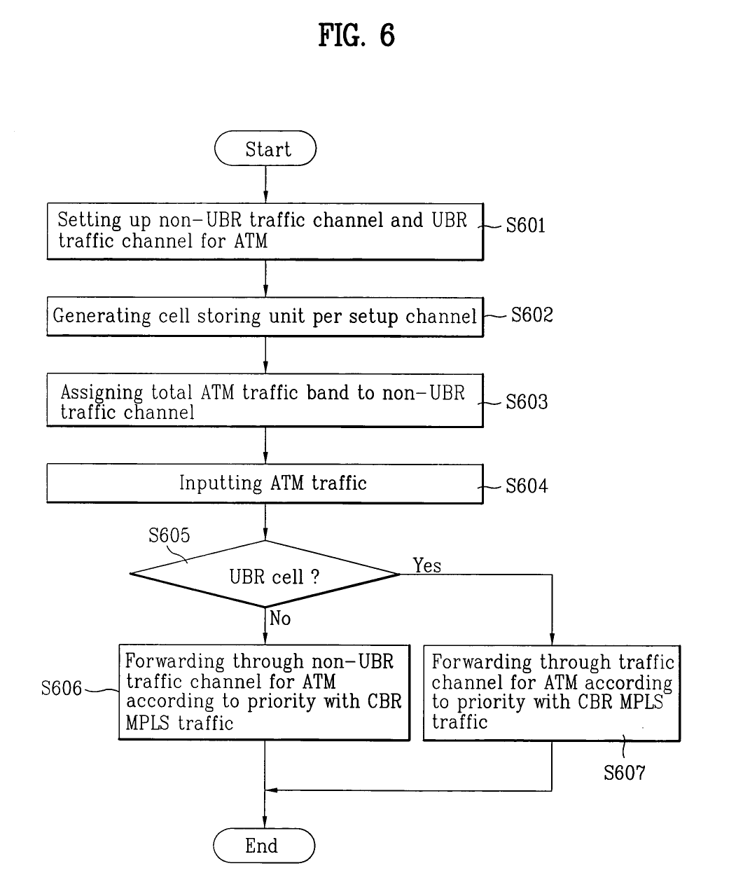

FIG. 6 is a detailed flowchart of a traffic forwarding method in an ATM based MPLS system according to another embodiment of the present invention.

Referring to FIG. 6, the corresponding forwarding engine 230 sets up one non-UBR traffic channel and one UBR traffic channel for forwarding of the inputted ATM traffic (S601), and generates the non-UBR cell buffer 251 and the UBR cell buffer 252 for the setup channels, respectively (S602).

The ATM traffic band received from the system control unit 270 of the system through IPC, i.e., the band corresponding to the total ATM traffic bands of the respective channels is assigned to the setup non-UBR traffic channel (S603).

Thereafter, the ATM traffic is inputted (S604). It is then checked whether the inputted ATM traffic is a UBR cell or not (S605). If the inputted ATM traffic is a CBR, RT-VBR, or NRT-VBR cell instead of a UBR cell, the traffic is stored in the non-UBR buffer 251 and then forwarded to the assigned band through the non-UBR traffic channel according to the priority with the CBR cell of the MPLS traffic (S606). If the inputted ATM traffic is a UBR cell, the traffic is stored in the UBR cell buffer 252 and then forwarded through the UBR traffic channel according to the priority of the UBR cell of the MPLS traffic (S607).

If all cells are stored in the non-UBR and UBR cell buffers 251 and 252 of the ATM traffic and the CBR, RT-VBR, NRT-VBR, and UBR cell buffer units 254, 255, 256, and 257 of the MPLS traffic, the scheduler 260 first performs forwarding processing on the non-UBR cell of the ATM traffic and the CBR cell of the MPLS traffic by a round robin method for example, then processes the RT-VBR and NRT-VBR cells of the MPLS traffic, and finally performs forwarding processing on the UBR cells of the ATM and MPLS traffic by the Round Robin method.

Thus, the forwarding engine of the MPLS system according to the present invention processes the ATM traffic together with the MPLS traffic, thereby mitigrating and preventing the difficulty of implementation and system complexity resulting from processing the ATM and MPLS traffic separately.

Moreover, in processing the ATM traffic, the entire subscriber channels assigned to the ATM traffic are divided into two channels such as the non-UBR traffic rate channel and the UBR traffic rate channel to perform the processing according to the priority of the MPLS traffic. Therefore, the present invention minimizes the load resulted from processing he ATM traffic for each subscriber channel, thereby enhancing the performance of the forwarding engine and the quality of service (QoS) of the traffic.

In the present invention, the buffer for processing the MPLS traffic includes a plurality of buffers corresponding to the subscriber channels. Yet, in performing processing of the ATM traffic, the forwarding processing is performed on ATM traffic inputted through a single buffer and single channel for a plurality of subscriber channels. Hence, there have been difficulties in controlling, since connections are achieved for the channels, respectively. An embodiment of connecting structure of the present invention facilitates control as well as reduces the number of buffers handled by the scheduler, which decreases the load of the scheduler. Therefore, the present invention enhances system performance. Moreover, in constructing and controlling the respective connection tables in the control block included in the forwarding engine, the present invention simplifies the respective connection tables to reduce the load for the table construction, thereby further enhancing system performance.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A traffic forwarding method in an asynchronous transfer mode (ATM) based multi-protocol label switching (MPLS) system, comprising:
classifying by rate, traffic inputted to an egress through at least one channel;
acquiring a total of channel bandwidths of ATM traffic of the inputted traffic corresponding to at least one setup rate; and
forwarding the ATM traffic corresponding to the setup rate through a single channel having the acquired bandwidth.

2. The traffic forwarding method of claim 1, further comprising forwarding MPLS traffic of the inputted traffic by subscriber channel according to a priority of the classified rate.

3. The traffic forwarding method of claim 2, further comprising the steps of:
performing processing on a second layer of the forwarded traffic; and
matching the processed traffic to a physical layer.

4. The traffic forwarding method of claim 1, wherein the rate includes constant bit rate (CBR), real-time variable bit rate (RT-VBR), (NRT-VBR), and unspecified bit rate (UBR), in hierarchical order.

5. The traffic forwarding method of claim 4, wherein the setup rate includes CBR, RT-VBR, and NRT-VBR rates.

6. The traffic forwarding method of claim 1, wherein the ATM traffic corresponding to the setup rate is real-time traffic.

7. A traffic forwarding method in an asynchronous transfer mode (ATM) based multi-protocol label switching (MPLS) system, comprising:
classifying ATM traffic of traffic inputted to an egress through at least one channel, into non-unspecified bit rate (UBR) traffic and UBR traffic;
finding a total of channel bandwidths assigned to the classified non-UBR traffic; and
forwarding the classified non-UBR traffic through a single channel having a bandwidth amounting to the found total.

8. The traffic forwarding method of claim 7, further comprising:
classifying MPLS traffic of the inputted traffic by rate; and
forwarding the MPLS traffic by channel according to a priority of the classified rate.

9. The traffic forwarding method of claim 8, further comprising:
performing processing on a second layer of the forwarded traffic; and
matching the processed traffic to a physical layer.

10. The traffic forwarding method of claim 8, wherein the rate includes constant bit rate (CBR), real-time variable rate (RT-VBR), non-real-time variable bit rate NRT-VBR), and unspecified bit rate (UBR), in hierarchical order.

11. The traffic forwarding method of claim 10, wherein ATM traffic of the non-UBR rate is forwarded with a same priority as the MPLS traffic of the CBR rate.

12. The traffic forwarding method of claim 11, wherein the ATM traffic of the non-UBR rate and the MPLS traffic of the CBR rate are forwarded by a round robin method when simultaneously inputted.

13. A traffic forwarding apparatus in an asynchronous transfer mode (ATM) based multi-protocol label switching (MPLS) system, comprising:
a traffic rate classifying unit classifying traffic inputted to an egress by rate, wherein ATM traffic of the inputted traffic is classified into a non-unspecified bit rate (UBR) traffic rate and a UBR traffic rate, and wherein MPLS traffic of the inputted traffic are classified into constant bit rate (CBR), real-time variable bit rate (RT-VBR), non-real-time variable bit rate (NRT-VBR), and unspecified bit rate (UBR), in hierarchical order;
a traffic storing unit comprising an ATM traffic storing unit having a first buffer buffering the ATM traffic corresponding to the non-UBR rate and a second buffer buffering the ATM traffic c-corresponding to the UBR rate and an MPLS traffic storing unit having a plurality of buffers buffering the MPLS traffic by classified rate and by channel; and
a scheduler forwarding traffic stored in the traffic storing unit according to a priority of each of the classified rates.

14. The traffic forwarding apparatus of claim 13, wherein the non-UBR traffic rate includes CBR, RT-VBR rate, and NRT-VR rates.

15. The traffic forwarding apparatus of claim 13, wherein the scheduler forwards the ATM traffic of the non-UBR rate stored in the first buffer unit with the same priority of the MPLS traffic of the CBR rate.

16. The traffic forwarding apparatus of claim 13, wherein the scheduler finds a total of channel bandwidths of the ATM traffic corresponding to the non-UBR rate and forwards the ATM traffic stored in the first buffer unit through a single channel having a bandwidth amounting to the found total.

17. The traffic forwarding apparatus of claim 13, further comprising:
an ATM processing unit performing processing on a second layer of the forwarded traffic; and
a physical layer matching unit matching the processed traffic to a physical layer.

18. A traffic forwarding method, comprising:
classifying inputted traffic by a classification rate;
acquiring a total channel bandwidth of asynchronous transfer mode traffic corresponding to at least one setup rate; and
forwarding the asynchronous transfer mode traffic corresponding to the setup rate;
wherein said forwarding the asynchronous transfer mode traffic occurs through a single channel having said acquired bandwidth.

19. The traffic forwarding method of claim 18, further comprising:
forwarding multi-protocol label switching traffic by subscriber channel;
performing processing on a second layer of said forwarded traffic; and
matching said processed traffic to a physical layer;
wherein said forwarding multi-protocol label switching traffic occurs according to a priority of the classification rate.

20. The traffic forwarding method of claim 18, wherein the classification rate includes a constant bit rate, a real-time variable bit rate, a non-real-time variable bit rate, and an unspecified bit rate, in hierarchical order.

21. The traffic forwarding method of claim 19, wherein the classification rate includes a constant bit rate, a real-time variable bit rate, a non-real-time variable bit rate, and an unspecified bit rate, in hierarchical order.

22. The traffic forwarding method of claim 18, wherein the setup rate includes a constant bit rate, a real-time variable bit rate, and a non-real-time variable bit rate.

23. The traffic forwarding method of claim 22, wherein the setup rate is real-time traffic.

24. A traffic forwarding apparatus, comprising:
a traffic rate classifying unit;
a traffic storing unit; and
a scheduler;
wherein said traffic rate classifying unit classifies asynchronous transfer mode traffic by unspecified bit rate and non-unspecified bit rate.

25. The traffic forwarding apparatus of claim 24, wherein said traffic storing unit further comprises:
an asynchronous transfer mode traffic storing unit; and
a multi-protocol label switching traffic storing unit.

26. The traffic forwarding apparatus of claim 25, wherein said asynchronous transfer mode traffic storing unit further comprises:
a first buffer buffering asynchronous transfer mode traffic corresponding to the non-unspecified bit rate; and
a second buffer buffering asynchronous transfer mode traffic corresponding to the unspecified bit rate.

27. The traffic forwarding apparatus of claim 25, wherein said multi-protocol label switching traffic storing unit further comprises a plurality of buffers buffering multi-protocol label switching traffic by a classification rate and by channel.

28. The traffic forwarding apparatus of claim 24, wherein said traffic rate classifying unit classifies multi-protocol label switching traffic by constant bit rate, real-time variable bit rate, non-real-time variable bit rate, and unspecified bit rate.

29. The traffic forwarding apparatus of claim 24, wherein said scheduler forwards traffic stored in said traffic storing unit according to a priority of each of a classified rate.

30. The traffic forwarding apparatus of claim 24, further comprising:
an asynchronous transfer mode processing unit performing processing on a second layer of forwarded traffic; and
a physical layer matching unit matching processed traffic to a physical layer.

31. The traffic forwarding apparatus of claim 28, wherein said asynchronous transfer mode traffic storing unit further comprises:
a first buffer buffering asynchronous transfer mode traffic corresponding to the non-unspecified bit rate; and
a second buffer buffering asynchronous transfer mode traffic corresponding to the unspecified bit rate.

32. The traffic forwarding apparatus of claim 31, wherein said scheduler forwards asynchronous transfer mode traffic of the non-unspecified bit rate stored in said first buffer with the same priority of the multi-protocol label switching traffic of constant bit rate, finds a total channel bandwidth of asynchronous transfer mode traffic corresponding to non-unspecified bit rate, and forwards the asynchronous transfer mode traffic stored in said first buffer through a single channel having a bandwidth equal to the total channel bandwidth.
